(19) United States
(12) Patent Application Publication
(10) Pub. No.: US 2021/0299958 A1
(43) Pub. Date: Sep. 30, 2021

(54) Shrinkable platform for 3D printer

(71) Applicants: Karl Joseph Dodds Gifford, Norcross, GA (US); Tue Nguyen, Fremont, CA (US)

(72) Inventors: Karl Joseph Dodds Gifford, Norcross, GA (US); Tue Nguyen, Fremont, CA (US)

(21) Appl. No.: 16/833,540

(22) Filed: Mar. 28, 2020

(51) Int. Cl. B29C 64/245; B29C 64/295; B29C 64/209; B29C 64/241; B29C 64/232; B29C 64/236

(52) U.S. Cl. CPC B29C 64/245; B29C 64/295; B29C 64/209; B33Y 30/00; B29C 64/232; B29C 64/236; B29C 64/241

(57) ABSTRACT

A rotatable and shrinkable platform for a 3d printer system can include multiple segments disposed next to each other around the axis of rotation. The segments can move between a printing configuration and a shrunk configuration. In the printing configuration, the segments are continuously and smoothly disposed next to each other to present a printing surface suitable for printing. In the shrunk configuration, the segments are overlapped to break the adhesion of a printed object with the platform to facilitate the removal of the printed object from the platform.

### BACKGROUND OF THE INVENTION

3D printers can be used to build solid objects by printing layers by layers of building materials. The building materials can be in liquid or semi liquid form at the 3D printhead, for example, a solid material can be heated and then extruded from a 3D printer nozzle. The layers of building materials can be solidified on a substrate.

3D printer systems can use a fused filament fabrication (FFF) process (sometimes called fused deposition modeling (FDM) process) in which a filament is moved, e.g., by a filament moving mechanism, toward a heated zone. The filament can be melted, and extruded on a platform to form a 3D object. The melted filament can adhere to the walls of the heated printhead, resulting in deformed printed lines.

It would therefore be advantageous to have advanced 3D printing systems and methods that have improved printing mechanisms.

### SUMMARY OF THE EMBODIMENTS

In some embodiments, the present invention discloses a rotatable and shrinkable platform for a 3D printer system. The rotatable and shrinkable platform can is rotatable around an axis of rotation, for example, by coupling to a rotating mechanism including a motor. The rotatable and shrinkable platform can include multiple segments disposed next to each other around the axis of rotation. The segments can include a recess end having a recess and an opposite portion end having a shaped portion, which is configured or shaped to fit at least partially in the recess.

The segments can be coupled to a moving mechanism, such as to a motor or a hydraulic or pneumatic cylinder to move the segments between a printing configuration and a shrunk configuration. In the printing configuration, the segments are next to each other to present a printable surface for the 3D printer, with the interface between the external surfaces of two adjacent segments substantially continuous and smooth, e.g., without any non-printable gaps or steps.

In the shrunk configuration, the segments are moved inward away from the printing surface to break the adhesion between the platform and the printed object, which can facilitate the removal of the printed object from the platform. The segments are overlapped to present a smaller overall platform surface, for example, by the portion end disposed partially in the recess end of the segments.

In some embodiments, the present invention discloses a 3D printer system incorporating a rotatable and shrinkable platform, together with an attachment for a 3D printer system having a rotatable and shrinkable platform.

### BRIEF DESCRIPTION OF THE DRAWINGS

FIGS. 1A-1C illustrate a prior art 3D printer system according to some embodiments.

FIGS. 2A-2B illustrate a configuration for a 3D printer system having a rotatable platform according to some embodiments.

FIGS. 3A-3B illustrate different configurations of the segmented platform according to some embodiments.

FIGS. 4A-4B illustrate operation of the segments of a platform according to some embodiments.

FIGS. 5A-5C illustrate processes for forming shrinkable platforms according to some embodiments.

FIGS. 6A-6C illustrate processes for forming 3D printers having a shrinkable platform according to some embodiments.

FIGS. 7A-7C illustrate processes for printing objects in a 3D printer having a shrinkable platform according to some embodiments.

FIGS. 8A-8F illustrate configurations for shrinkable platforms according to some embodiments.

FIGS. 9A-9F illustrate printing surface cross sections of a shrinkable platform according to some embodiments.

FIGS. 10A-10D illustrate configurations for shrinkable platforms according to some embodiments.

FIGS. 11A-11D illustrate configuration for a segmented platform according to some embodiments.

FIGS. 12A-12B illustrate a shrinkable platform according to some embodiments.

FIGS. 13A-13C illustrate processes for forming shrunk platforms according to some embodiments.

FIGS. 14A-14D illustrate processes for forming shrunk platforms according to some embodiments.

FIGS. 15A-15D illustrate movement configurations of a segmented platform according to some embodiments.

FIGS. 16A-16B illustrate configurations of a segmented platform in which the segments are rotatable according to some embodiments.

FIGS. 17A-17D illustrate movement configurations of a segmented platform according to some embodiments.

FIGS. 18A-18B illustrate configurations of a segmented platform in which the segments are rotatable according to some embodiments.

FIGS. 19A-19C illustrate a configuration of a segmented platform according to some embodiments.

FIGS. 20A-20B illustrate a configuration of a segmented platform according to some embodiments.

FIGS. 21A-21B illustrate configurations and operations of a segmented platform according to some embodiments.

FIG. 22 illustrates an attachment coupled to a 3D printer according to some embodiments.

### DETAILED DESCRIPTION OF THE EMBODIMENTS

In some embodiments, the present invention discloses systems and methods for 3D printing, using a shrinkable and rotatable platform. The rotatable platform can include a platform having a printing surface that can be rotated during the 3D printing process, such as a cylindrical platform or other platforms having a closed curve cross sectional circumference through the printing surface and cut through the axis of rotation. The shrinkable platform can have the printing surface shrunk, e.g., reduced in radial directions to have a smaller cross sectional area. The shrunk surface of the platform can assist in the removal of the printed structure, such as allowing the printed structure to slide off the platform.

Additive manufacturing processes generally fabricate 3D objects by depositing layers by layers in patterns corresponding to the shape of the objects. At each layer, a print head can deposit building materials at locations corresponded to the pattern of the object for that layer.

3D printing processes can include inkjet printing, stereolithography and fused filament fabrication. In inkjet printing processes, liquid material are released from an inkjet print head, and solidified on the substrate surface, e.g., on the model being formed. In stereolithography processes, a UV light can cros slink layers of photopolymer. In fused filament fabrication processes, a continuous filament of thermoplastic can be softened or melted and then re-solidified on a previously deposited layer. Alternatively, paste-like materials can be used for printing, for example, through a pressure extrusion device such as a piton/cylinder.

Various polymers are used, including acrylonitrile butadiene styrene (ABS), polycarbonate (PC), polylactic acid (PLA), high density polyethylene (HDPE), PC/ABS, and polyphenylsulfone (PPSU). Other materials can be used, such as clay or ceramic materials.

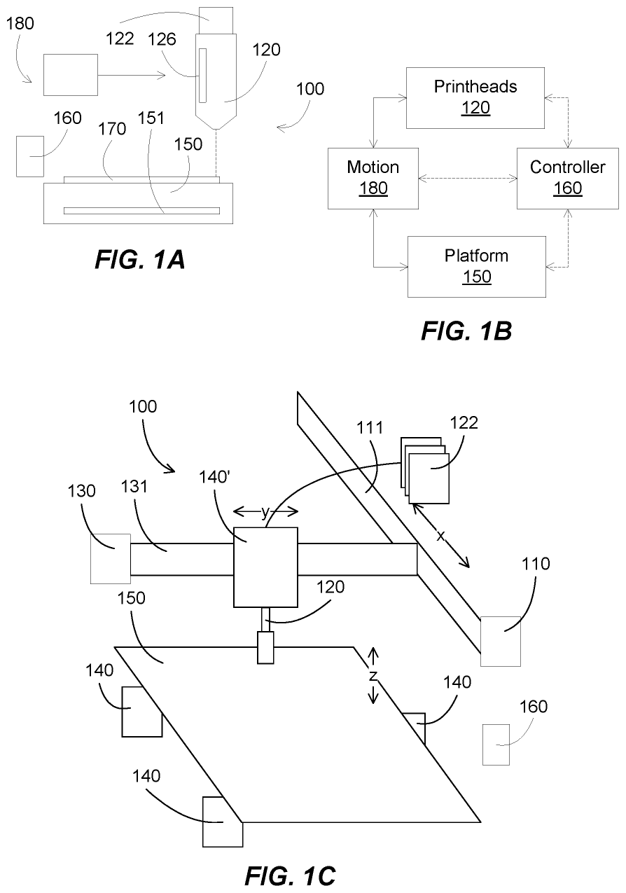

FIGS. 1A-1C illustrate a prior art 3D printer system according to some embodiments. FIG. 1A shows a 2D mechanical schematic, FIG. 1B shows an electrical schematic, and FIG. 1C shows a 3D schematic of a 3D printer system. The 3D printer system can include a printhead module 120 for printing an object 170 on a platform module 150. The printhead module 120 can include a delivery module, which is configured to deliver printing materials to a print head. The print head can be heated by a heater 126, for example, to a temperature that can soften or melt the printing materials 122. The delivery module can push the melted printing materials through the print head, so that the printing materials can be deposited on the platform of the platform module 150 to form a printed object 170. The printhead module 120 can accommodate multiple printheads, e.g., one or more printheads.

A printhead can be configured for extruding from a filament material. A filament, such as a thermoplastic filament, can be provided to a delivery module. The delivery module can include a mechanism to regulate the flow of filament material. For example, a worm-drive or rotating gears can be used to push the filament into the printhead at a controlled rate. The printhead can include a heater, which can heat the filament material to a temperature that can melt or soften the filament material, for example, to a temperature higher than the glass transition temperature of the filament material. The printhead can be thermally isolated from the delivery module, for example, by a low temperature coefficient material.

A printhead can be configured for extruding from a paste-like material. Paste-like material, such as plasticine or a ceramic paste, can be provided to a delivery module. The delivery module can include a mechanism to deliver the paste-like material, such as a piston/cylinder configuration. For example, a paste-like material can be disposed in a cylinder, and can be pressed by a piston so that the paste-like material can be pushed into the printhead at a controlled rate.

A printhead can be configured for extruding from a liquid-like material. Liquid-like material, such as liquid polymer, can be provided to a delivery module. The delivery module can include a mechanism to deliver the liquid-like material, such as a liquid pump configuration. For example, a liquid-like material can be disposed in a reservoir, and can be pumped by a peristaltic pump so that the liquid-like material can be delivered to a platform support at a controlled rate.

Other printheads can be used, such as a laser head for cutting materials, a cutter head for removing materials from the workpiece, and a pen head for writing on the workpiece.

The printhead module 120 can include other components, such as a thermal isolation element, disposed between the heated print head and the delivery module, for example, to prevent heating the supplied printing materials in the delivery module. The platform module 150 can include other components, such as a heater 151, which can heat the platform surface.

The 3D printer system can include a motion module 180, which can be configured to provide motions of the printhead module 120 relative to the platform module 150, in 3D motions, such as x, y, and z directions in linear 3D printer systems, or 3 z directions in delta 3D printer systems. For example, the printhead can move in a horizontal direction, such as y. The platform can move in a horizontal direction such as x, together with a vertical direction such as z. Other movement configurations can be used to provide complete 3D movements of the printhead relative to the platform.

The 3D printer system can include a controller module 140, for example, a computer or a microcontroller for controlling the printhead module, the motion module, and the platform module.

FIG. 1C shows a configuration for a 3D printer 100, in which a print head is configured to print on a platform 150. The print head can be coupled to a material delivery system 122, which can deliver materials to the print head. The print head 120 can be coupled to a y movement mechanism, such which can include a linear guide 131, which is driven by a motor 130. The print head and the y movement mechanism can be coupled to an x movement mechanism, which can include a linear guide 111, which is driven by a motor 110.

A z movement mechanism 140′ can be coupled to the print head 120 for moving the print head in the z direction. An alternative z movement mechanism 140 can be coupled to the platform 150 to move the platform in the z direction. A controller 160 can be used to control the 3D printer system.

In some embodiments, the present invention discloses a rotating platform, such as a rotating cylindrical platform, and a 3D printer system that is configured to print on the rotating platform, such as on the cylindrical surface of the rotating cylindrical platform. In general, the rotating platform can be any platform that is coupled to a rotating mechanism, such as to a rotating motor, to rotate the platform. For example, a half circle platform can be used as a print surface, with the print head printing on the half circle surface. The half circle platform can rotate back and forth, such as from -90 to 90 degrees and then back to -90 degrees.

Alternatively, closed curve platforms can be used, to allow continuous printing in the rotating direction. For example, a cylindrical platform can be used as the print surface, with the print head printing on the cylindrical surface. The cylindrical platform can rotate continuously, instead of rotating back and forth.

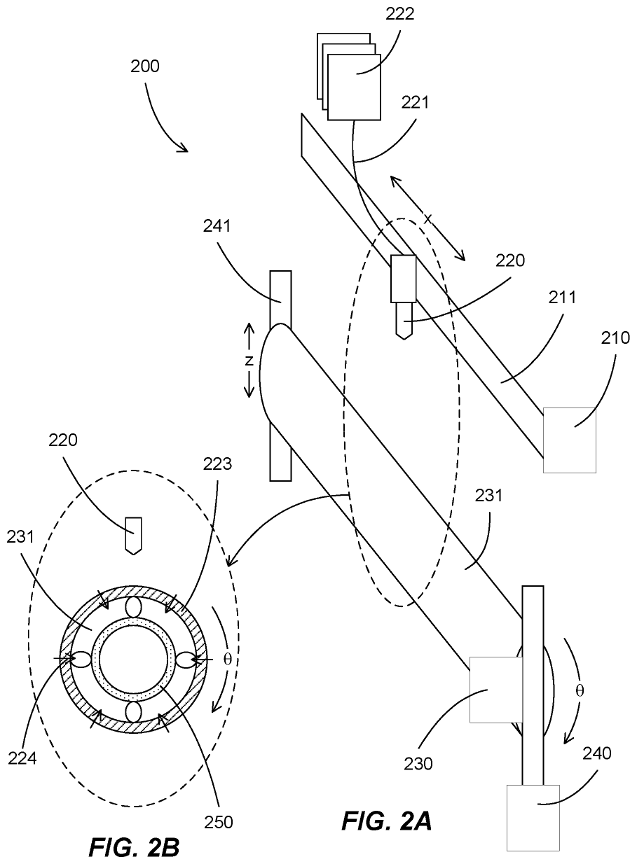

FIGS. 2A-2B illustrate a configuration for a 3D printer system having a rotatable platform according to some embodiments. A 3D printer system 200 can have a rotatable platform 231, such as a cylindrical platform coupled to a rotating mechanism having a motor 231. The rotatable platform can include a heater 250 for heating the printing surface of the platform. The 3D printer system thus can be used to print pipe shapes, such as pipes, pipe tees or elbows.

The 3D printer system can include a print head 220, which is coupled to a first movement mechanism that can move the print head in a linear direction such as an x direction. The movement mechanism can include a motor 210, which can be configured to move the print head along a linear guide 211. The x linear direction can be parallel to the axis of rotation of the rotatable platform, for example, the x direction can be configured so that the print head can print on the platform, such as printing on a straight x line on the platform when the platform is stationary and the print head moves along the x direction. When the platform is rotating, the print head can print on a spiral line, advancing in the x direction.

A material delivery system 222 can be coupled to the print head to provide the material to the print head. For example, the delivery system can be configured to provide a filament 221 to the print head.

The rotatable platform 231 can be coupled to a second movement mechanism that can move the platform, and the rotating mechanism coupled to the platform, in a linear direction such as a z direction. The platform can move down layer-by-layer along the z direction, after the print head finishes printing a layer on the platform.

FIG. 2B shows a cross sectional view of the platform. After the object is printed, such as a printed pipe 223, the print head 220 can retract away from the printed object. The printed object can be bonded well to the platform, for example, by the adhesion and contraction force 224 between the object 223 and the platform 231.

The printed object can have good adhesion with the platform surface, for example, to prevent curving of the printed object due to the cooling of the object. For an object printed on a rotating platform, such as a pipe or a ring, the high adhesion, together with the shrinking of the printed object when cooled down, can make the object sticking well to the rotating platform, especially for a closed curve platform. This high adhesion of the printed object to the platform can make it difficult to remove the printed object, for example, there is no exposed area to apply a shear force to remove the printed object.

In some embodiments, the present invention discloses a shrinkable platform, e.g. the surface of the platform can be shrunk to a smaller surface area. The shrunk surface of the platform can eliminate the adhesion by moving the printing surface away from the bottom surface of the printed object. With the object separated from the platform, the object can be easily removed from the platform.

For example, the rotating platform can have a printing surface, on which a print head can deliver materials to form a printed object. After the object is printed, the printing surface of the platform can shrink, e.g., the platform now has a smaller surface area, which is then decoupled from the printed object. The printed object can be removed from the platform.

In some embodiments, the shrinkable platform can include multiple segments connected adjacent to each other to provide a printing surface. The segments can be disposed right next to each other without non-printable gaps, such as to form a continuous, or substantially continuous printing surface. The non-printable gap can be a large gap so that when the print head print across the gap, the printed line can show a visible sag. The non-printable gap can be gaps larger than 5 mm, or 3 mm, or 1 mm. The non-printable gap can be a smaller gap so that when the print head print along the gap, at least a portion of the printed line can be on the platform surface, e.g., the gap should be small enough so that a printed line cannot fall through the gap. The non-printable gap can be gaps larger than twice the width of the printed lines, such as larger than 2 mm, or 1 mm, or 0.8 mm.

The segments can be disposed right next to each other without non-printable steps, such as to form a smooth, or substantially smooth printing surface. The non-printable step can be a large step so that when the print head print across the step, the printed line can show a visible height difference. The non-printable step can be steps larger than 2 mm, or 1 mm, or 0.5 mm.

The segments can be rearranged so that the segments move inward, e.g., away from the bottom surface of the printed object. The bottom surface of the printed object is the interface surface between the printed object and the platform, which can be the printing surface. For example, the platform can be a cylindrical platform, and the segments can move toward a center or an inside area of the platform.

With the segments move away from the printed object, the movements break the adhesion and provide a space between the object and the platform. The object is thus loose from the platform, and can be easily removed from the platform.

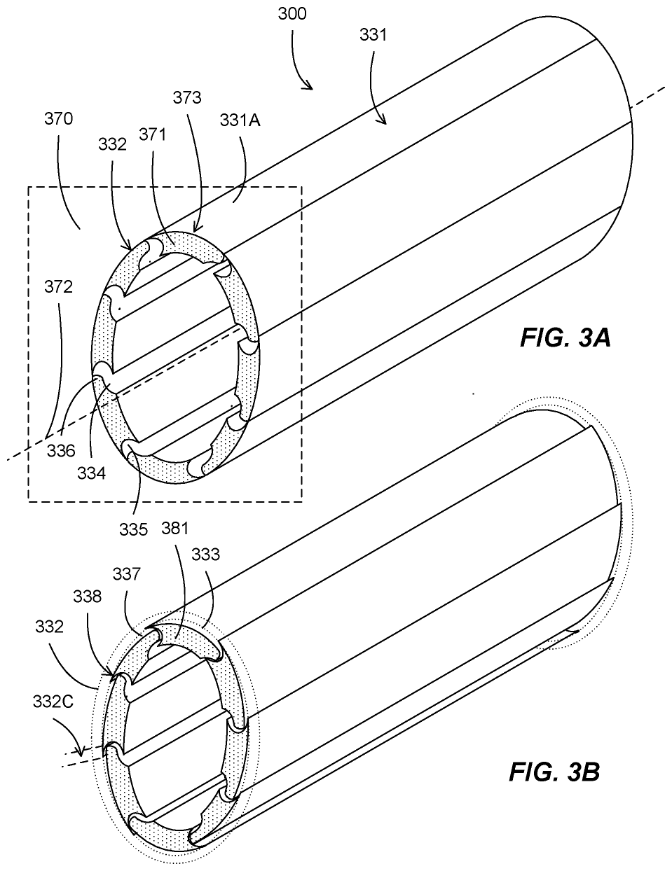

FIGS. 3A-3B illustrate different configurations of the segmented platform according to some embodiments. A platform 300 can include multiple segments 331 disposed next to each other. The platform can be configured to rotate around an axis of rotation 372, for example, by coupling to a motor through a gear set or a timing belt. A print head can be disposed next to the platform, such as above the platform. The print head can be configured to move along a linear direction, such as by coupling to a linear guide and motor driver to move along the direction of the axis of rotation. Together with the rotation of the platform, the linear movement of the print head can allow the print head to cover all surface of the platform.

FIG. 3A shows a first configuration of the platform in which the segments of the platform are positioned to form a printing surface for printing. Segments of the platform, such as segments 331, can each have an external surface 331A. The external surfaces of the segments can form the printing surface on which a print head of a 3D printer can print. The segments can be disposed adjacent of each other so that the external surfaces form a printing surface that is substantially continuous and smooth, e.g. without non-printable gaps or steps as mentioned above. For example, each segment can be disposed between two adjacent segments, and together the segments form a simple closed curve, such as a circle or an ellipse, or other curves such as a polygon or a combination of different polygons.

Cross sectional areas 371 of the segments 331, formed by a plane 370 slicing through the platform perpendicular to the axis of rotation 372, are disposed inside and contacting a simple closed curve 332, which surrounds the axis of rotation 372. For example, the cross sectional areas 371 can be in contact with the external surfaces 331A, e.g., with the intersection of the external surfaces 331A with the slicing plane 370. The intersection of the external surfaces 331A with the slicing plane 370 can be a side of the cross sectional areas 371, e.g., the simple closed curve 332 can include sections, such as arcs, of the intersection of the external surfaces 331A with the plane 370.

The simple closed curve 332 can be the intersection of the plane 370 with the printing surface of the platform, e.g., with the external surfaces 331A of the segments 331. Since the external surfaces are disposed next to each other with substantially no gaps or no steps, the external surfaces can form a substantially smooth and continuous printing surface, which can intersect the cross sectional plane 370 to form the simple closed curve.

FIG. 3B shows a second configuration of the platform in which the segments are positioned to allow the printed object to be easily removed from the platform. The segments can move from the printing position, e.g., the first configuration, to the removing position, e.g., the second position, for breaking the adhesion between the printed object and the platform.

In the second configuration, the platform is shrunk from the first configuration. In the shrunk configuration, the external surfaces 331A of the segments are spaced apart from the bottom surface of the printed object. For example, the cross sectional areas 371 of the segments can be inside and spaced apart from the closed curve 332. The space apart distances can be uniform, or can be different at different locations of the segments.

In the shrunk platform configuration, the segments can be rearranged to be contained inside a second simple closed curve 333, which is a shrunk first simple closed curve 332 that contains the segments in the first configuration. For example, at least a segment of the multiple segments is coupled to a moving mechanism for moving to form the shrunk platform. At the shrunk platform position, the external surface of the at least a segment is inside the simple closed curve formed by the unshrunk platform and spaced apart from the simple closed curve. Cross sectional areas 381 of the segments 331 in the second configuration, formed by the same plane 370, are disposed inside and not contacting a simple closed curve 332, e.g., the segments 331 in the second configuration are spaced apart from the simple closed curve 332. The cross sectional areas 381 are also disposed inside the second simple closed curve 333.

The second simple closed curve 333 can be a uniformly shrunk simple closed curve 332. The curve 333 can be uniformly spaced inward, e.g., shrunk uniformly, from the curve 332. Alternatively, the curve 333 can be offsetly shrunk or wrinklely shrunk.

In the second configuration, e.g., the shrunk platform configuration, the external surfaces 331A are spaced apart, e.g., not smoothly continuous as in the printing configuration. For example, the eternal surfaces can be staggered or overlapped along the circumferential line of the simple closed curve 333. The staggered or overlapped segments can allow the platform to be shrunk, e.g., to form a reduced total surface area from the printing surface.

In some embodiments, the segments are configured to be movable inward, e.g., toward the axis of rotation, from the printing configuration to form the shrunk configuration. For example, the segments can be bendable, so that in the shrunk configuration, the bent segments can provide a smaller area or smaller diameter curve, e.g., a shrunk closed curve. The segments can be rigid, and the segments can be configured to be movable inward with different radial distances, e.g., one end of the segment (such as the end 335, which is the end adjacent to another segment, such as adjacent to a left neighbor segment) can move inward at a smaller distance as compared to another end of the segment (such as the end 336, which is the end adjacent to another different segment, such as adjacent to a right neighbor segment). The movements of the segments can be accomplished by a rotational movement of the segments, such as by a motor coupled to the segment through a gear set, or by a hydraulic or air cylinder. The different radial distance movements of the segments can be configured to provide overlapped segments, for example, to form the shrunk closed curve.

In some embodiments, the segments are shaped to allow overlapping using simple movements. For example, the segments can be shaped so that during a rotational movement, a left segment (e.g., left in a counterclockwise direction) can slide under a right segment (e.g., advanced from the left segment in the clockwise direction).

For example, each segment can have a left end and a second end. The segments can be positioned so that the left end of one segment is disposed next to the right end of a left adjacent segment, and the right end of one segment is disposed next to the left end of a right adjacent segment.

In some embodiments, the segments can have a recess 335 at one end, for example, at the left end. The segments can have a portion 336 at an opposite end, such as at the right end. The portion 336 can have a cut 334, such as a tapered or chamfered portion, in order to fit, at least partially, in the recess 335. When the portion 336 is disposed at least partially in the recess, as shown at 338, the segments can be overlapped by a distance 332C. The overlapped sections can allow the segments to form a shrunk closed curve 333, which is smaller than the closed curve 332 of the printing surface.

In the overlap configuration, the right end (e.g., the portion) of the segment is closer to the axis of rotation as compared to the left end (e.g., the recess), since the portion is disposed in the recess. Thus, the external surfaces of the segments are not smooth and not continuous, e.g., there is a surface gap of at the overlap area 338 between the external surfaces of two adjacent segments. Further, while the external surfaces 331A of the segments in the printing configuration conform to the simple closed curve 332, the external surfaces in the shrunk configuration stagger or overlap with a gap in between. Further, one end, e.g., the end having the recess 335 can contact the shrunk simple closed curve 333, and the end having the portion 336 moves inward to have a gap 337 with the shrunk simple closed curve 333.

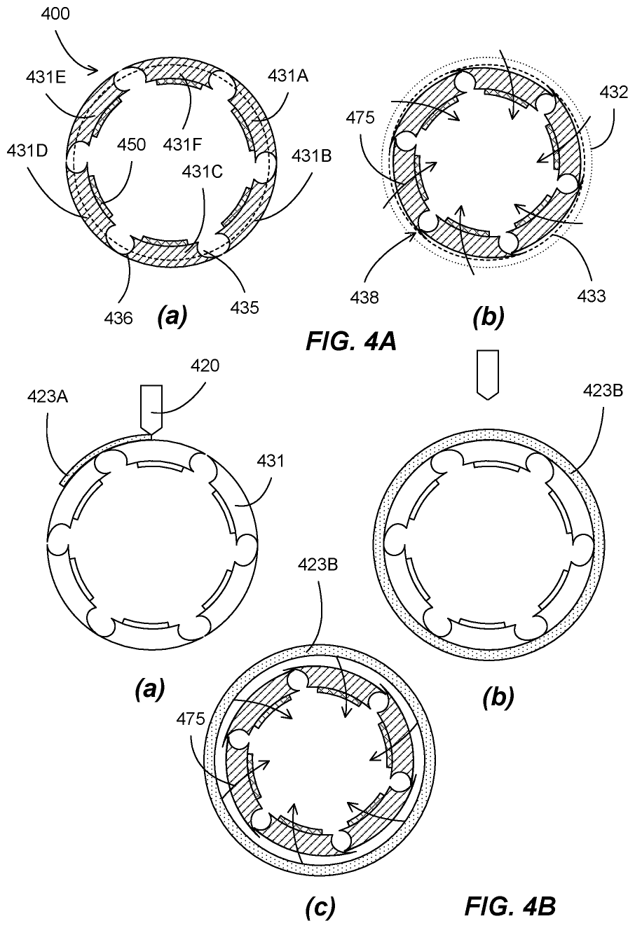

FIGS. 4A-4B illustrate operation of the segments of a platform according to some embodiments. FIGS. 4A(a) and 4A(b) show movements of the segments between a printing configuration and an object removing configuration. A platform 400 can have multiple segments, such as segments 431A-431F. Each segment can have a heater element 450 to heat the segment. The segments can be disposed next to each other to present a printing surface, which can be a simple closed curve 432, and which is substantially continuous and smooth. The segments can have a recess 435 at one end and a smaller portion 436 at an opposite end. The smaller portion 436 is configured to be able to at least partially dispose inside the recess 435.

The segments can move 475 to be inside a shrunk curve 433 from the simple closed curve 432. The movements of a segment can be such that the recess end 435 moves inward a distance less than that of the portion end 436. Thus, the recess end can contact the shrunk curve 433 while the portion end is spaced inward from the shrunk curve 433. Further, the portion end 436 is disposed at least partially inside the recess end 435.

FIGS. 4B(a)-4B(c) show a sequence of object printing and removing on the segmented platform. In FIG. 4B(a), the platform is in the printing configuration, with the segments 431 disposed next to each other to form a simple closed curve. A print head 420 can move toward the platform, and can print on the surface of the platform, forming a printed segment 423A. In FIG. 4B(b), the object 423B is printed, and the print head is removed, e.g., moved away, from the platform. In FIG. 4B(c), the segments of the platform move inward 475 to separate the segments 431 from the printed object 423B. The object then can be removed from the platform.

As shown, the printed object 423B completely surrounds the platform, e.g., forming a close curve object on all segments 431. Alternatively, the object 423B can partially cover the platform, e.g., printed on some segments 431, such as completely on some segments and partially on other segments.

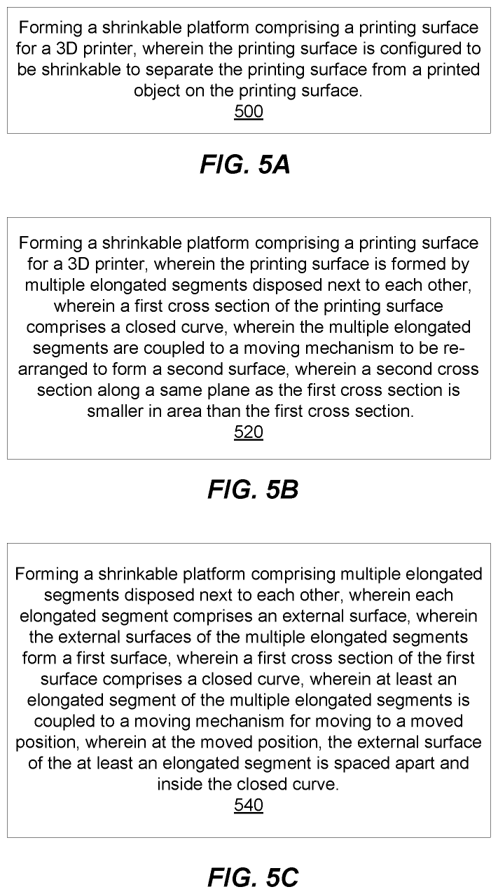

FIGS. 5A-5C illustrate processes for forming shrinkable platforms according to some embodiments. In FIG. 5A, operation 500 forms a shrinkable platform having a printing surface for a 3D printer with the printing surface configured to be shrinkable to separate the printing surface from a printed object on the printing surface. The platform can be shrunk in cross sectional area so that a simple closed curve containing the cross sectional area of the shrunk platform is smaller as compared to the cross sectional area of the original platform.

In FIG. 5B, operation 520 forms a shrinkable platform having a printing surface for a 3D printer. The printing surface is formed by multiple elongated segments disposed next to each other. A first cross section of the platform is a closed curve. The multiple elongated segments are coupled to a moving mechanism to be re-arranged to form a shrunk platform with a second cross section of the shrunk platform along a same plane as the first cross section is smaller in size or area.

In FIG. 5C, operation 540 forms a shrinkable platform having multiple elongated segments disposed next to each other. Each elongated segment having an external surface. The external surfaces of the multiple elongated segments are arranged to form a printing surface for a 3D printer with a cross section of the printing surface being a simple closed curve. At least an elongated segment of the multiple elongated segments is coupled to a moving mechanism for moving to form a shrunk platform. At the shrunk platform position, the external surface of the at least an elongated segment is inside the simple closed curve and spaced apart from the simple closed curve.

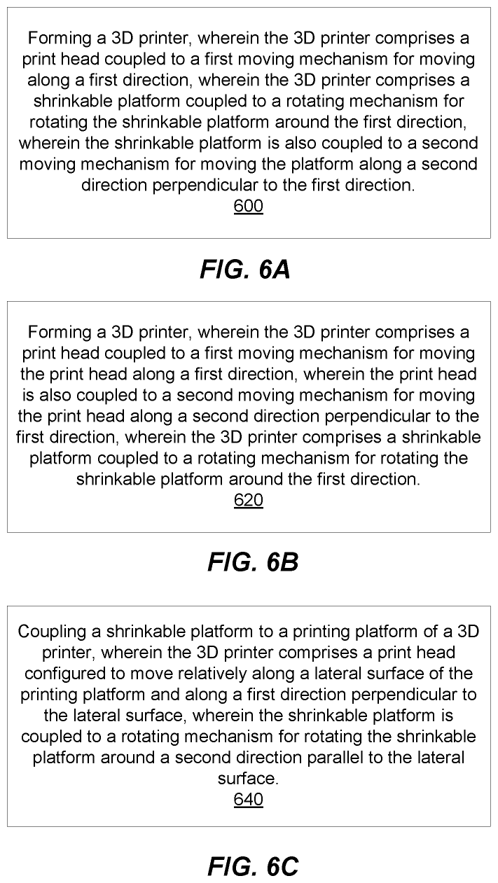

FIGS. 6A-6C illustrate processes for forming 3D printers having a shrinkable platform according to some embodiments. In FIG. 6A, operation 600 forms a 3D printer having a print head coupled to a first moving mechanism for moving the print head along a first direction, and a shrinkable platform coupled to a rotating mechanism for rotating the shrinkable platform around the first direction. The shrinkable platform is also coupled to a second moving mechanism for moving the platform along a second direction perpendicular to the first direction.

In FIG. 6B, operation 620 forms a 3D printer having a print head coupled to a first moving mechanism for moving the print head along a first direction. The print head is also coupled to a second moving mechanism for moving the print head along a second direction perpendicular to the first direction. The 3D printer also has a shrinkable platform coupled to a rotating mechanism for rotating the shrinkable platform around the first direction.

In FIG. 6C, operation 640 couples a shrinkable platform to a printing platform of a 3D printer. The 3D printer can have a print head configured to move relatively along a lateral surface of the printing platform and along a first direction perpendicular to the lateral surface. The shrinkable platform is coupled to a rotating mechanism for rotating the shrinkable platform around a second direction parallel to the lateral surface.

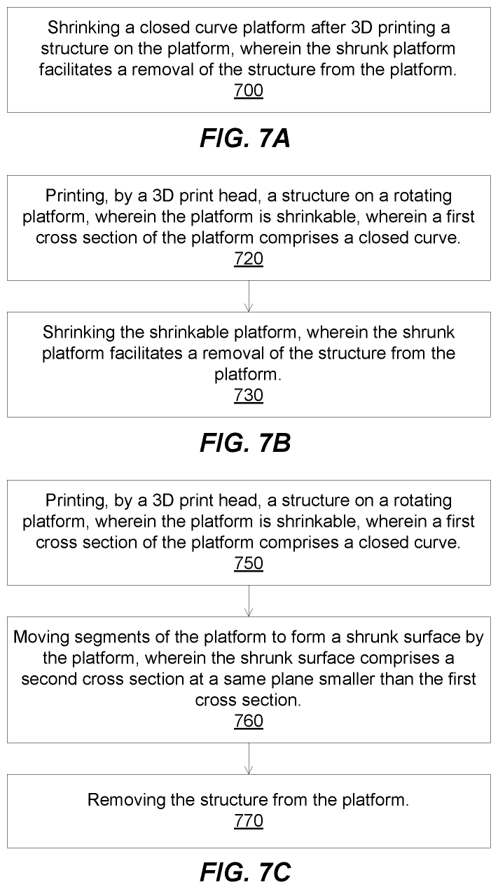

FIGS. 7A-7C illustrate processes for printing objects in a 3D printer having a shrinkable platform according to some embodiments. In FIG. 7A, operation 700 shrinks a simple closed curve platform after 3D printing an object on the platform, with the shrunk platform configured to facilitate a removal of the object from the platform.

In FIG. 7B, operation 720 prints, by a 3D print head, a structure on a rotating platform. The platform is shrinkable with a first cross section of the platform being a simple closed curve. Operation 730 shrinks the shrinkable platform to facilitate a removal of the structure from the platform.

In FIG. 7C, operation 750 prints, by a 3D print head, a structure on a rotating platform. The platform is shrinkable having multiple adjacent segments with a first cross section of the platform being a simple closed curve. Operation 760 moves the segments of the platform to form a shrunk surface by the platform. The shrunk surface has a second cross section at a same plane smaller than the first cross section. Operation 770 removes the structure from the platform.

In some embodiments, the present invention discloses a shrinkable and rotatable platform, which can be used to provide a printing surface for a 3D printer. The platform can have a cylindrical-like shape, e.g., a shape that a cross section of the printing surface perpendicular to the rotational axis forms a simple closed curve, such as a circle or an ellipse.

The platform is shrinkable or collapsible, meaning the simple closed curve representing the printing surface can be shrunk or reduced in area. The shrunk printing surface can separate the printed object from the platform, which can allow the printed object to be easily removed from the platform.

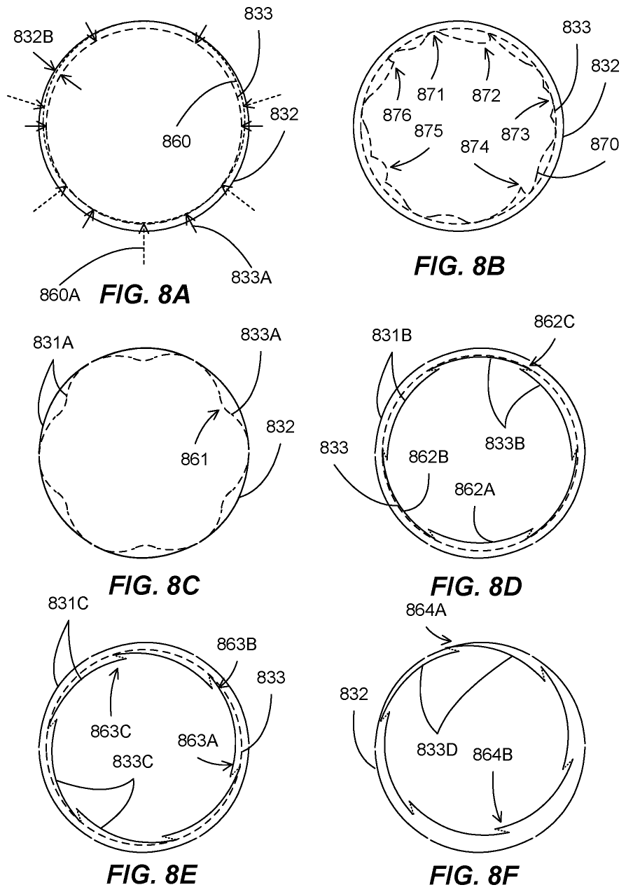

FIGS. 8A-8F illustrate configurations for shrinkable platforms according to some embodiments. In FIG. 8A, a cross section of the printing surface of a platform can form a simple closed curve, such as a circle 832. The printing surface can be shrunk uniformly 833A, e.g., the platform can be inside and not touching the simple closed curve 832, such as to be inside and touching in some portions of a curve 833, which is a uniform shrunk curve of the simple closed curve 832.

The printing surface can be shrunk nonuniformly 860A, e.g., the shrunk platform can be inside and touching the simple closed curve 832 at a few portions, such as touching one or two points. The shrunk platform can be inside and touching in some portion of a curve 860, which touches the curve 832 at one point, and not touching or contacting the curve 832 at other portions.

In FIG. 8B, the printing surface can be shrunk so that the platform can be irregularly inside and not touching the simple closed curve 832, such as to be inside and touching in some portions of a curve 833.

The printing surface can be shrunk irregularly, e.g., the shrunk platform can be inside and touching the curve 833 at some portions, such as touching at portions 871 and 873. Portions of the shrunk platform can curve smoothly inward with different curvatures 872, 875, and 876. Portions of the shrunk platform can curve abruptly inward, e.g., having a sharp corner 874.

In some embodiments, the platform can be configured to be shrinkable by composing of multiple movable segments. In a printing configuration, the segments are disposed next to each other to present a printing surface for a 3D printer. For example, the segments can be shaped with end-to-end matching, e.g., one end of the segment mates with an opposite end of an adjacent segment. The interface or the matching or the mating of two adjacent segments can be substantially continuous and smooth, e.g., continuous enough as to not presenting any non-printable gaps for the 3D printer, and smooth enough as not presenting any visible and discernible step on a printed object. The segments can be periodic, e.g., similar segments are arranged repeatably at an angular period. For example, the platform can be a cylindrical platform, and can include 6 segments. The segments are identical, arranged around a circle with a period of 60 degrees.

The segments are movable, for example, to a second position. In the second position, the platform, with the moved segments, forms a shrunk configuration, in which the segments, or portions of the segments, move inward, e.g., away from the external surfaces of the segments in the printing configuration. Thus, the segment external surfaces move away from the bottom surface of the printed object, since the object is printed on the external surfaces of the segments in the printing configuration.

The away-movement of the segments can break the adhesion of the segments with the printed object, since the printed object can be stationary during the movements of the platform segments.

In FIG. 8C, the printing surface can be bendable, so that the printing surface can be shrunk by one or more bends 861 in the platform surface. For example, the platform can include multiple segments 831A. Portions of the segments can bent inward to form the shrunk surface 833A of the platform in the shrunk configuration, e.g., shrunk from the printing surface 832 of the platform in the printing configuration.

In FIG. 8D, the printing surface can have some portions 862A moving inward more than other portions 862B, so that there are some overlapped portions 862C. The platform is thus shrunk to be inside and touching shrunk curve 833 at portions 862B. For example, the platform can include multiple segments 831B. Some segments 862B can move inward and contacting the shrunk curve 833. Some segments 862A can move further inward to be inside the uniform shrunk curve 833. The segments 862A can move inward first, followed by the segments 862B to form the shrunk surface 833B of the platform in the shrunk configuration, e.g., shrunk from the printing surface 832 of the platform in the printing configuration.

In FIG. 8E, the printing surface can have some portions 863A of a segment moving inward more than other portions 863B of the same segment, so that there are some overlapped portions 863C. The platform is thus shrunk to be inside and touching curve 833 at portions 863B. For example, the platform can include multiple segments 831C. One end 863A can move inward more than the other end 863B to provide an overlap 863C of the external surfaces. The end portion 863B can move inward and contacting the shrunk curve 833. The end portion 963A can move further inward to be inside the uniform shrunk curve 833. The different distances of the movements of different ends of the segments can form the shrunk surface 833C of the platform in the shrunk configuration, e.g., shrunk from the printing surface 832 of the platform in the printing configuration.

In FIG. 8F, the printing surface can have both segments and portions of same segments moving inward at different distances, so that there are some overlapped portions, and some offset distance from the printing surface 832. The platform is thus shrunk to be inside the printing curve 832 at portions 864B and touching the curve 832 at portions 864A. The different distances of the movements of the segments and the different ends of the segments can form the shrunk surface 833D of the platform in the shrunk configuration, e.g., shrunk from the printing surface 832 of the platform in the printing configuration. The shrunk surface 833D can be similar to the shrunk surface 833C with an offset distance caused by the different inward movements of the segments.

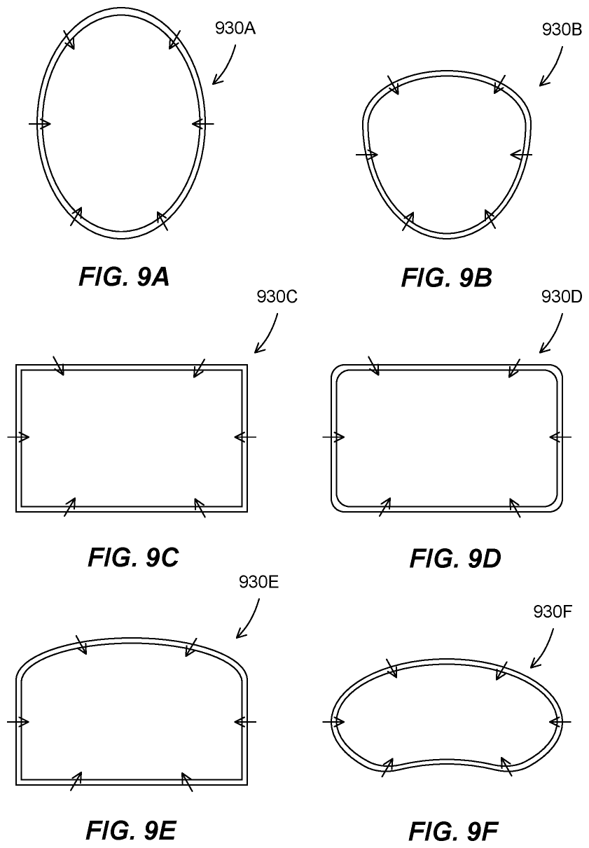

FIGS. 9A-9F illustrate printing surface cross sections of a shrinkable platform according to some embodiments. A platform can have multiple segments, with different portions of each segment configured to move differently to form a shrunk platform. In FIG. 8A, a cross section of the printing surface of a platform 930A can form an ellipse, which is a simple closed curve. The printing surface can be shrunk uniformly. In FIG. 8B, a cross section of the printing surface of a platform 930B can include portions of two ellipses joined together. The joint areas can be substantially smooth and continuous, or can have sharp points. In FIG. 8C, a cross section of the printing surface of a platform 930C can form a rectangle. In FIG. 8D, a cross section of the printing surface of a platform 930C can form a rounded or chamfered rectangle. In FIG. 8E, a cross section of the printing surface of a platform 930C can include portions of straight line polygons and curve polygons joined together, such as portions of a rectangle and an ellipse. In FIG. 8F, a cross section of the printing surface of a platform 930F can have different curvatures, such as having concave portions joined with convex portions. The radius of curvature can be large enough to present a printing surface without any non-printable area, such as a concave portion that is smaller than the print head size.

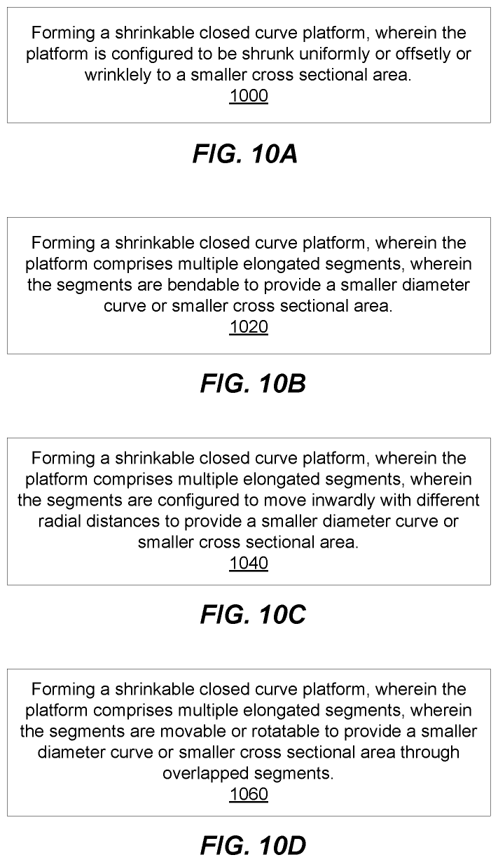

FIGS. 10A-10D illustrate configurations for shrinkable platforms according to some embodiments. In FIG. 10A, operation 1000 forms a shrinkable closed curve platform, which is configured to be shrunk uniformly or offsetly or wrinklely to a smaller cross sectional area.

In FIG. 10B, operation 1020 forms a shrinkable closed curve platform having multiple elongated segments. The segments are bendable to provide a smaller diameter curve or smaller cross sectional area.

In FIG. 10C, operation 1040 forms a shrinkable closed curve platform having multiple elongated segments, which are configured to move inwardly with different radial distances to provide a smaller diameter curve or smaller cross sectional area.

In FIG. 10D, operation 1060 forms a shrinkable closed curve platform having multiple elongated segments, which are movable or rotatable to provide a smaller diameter curve or smaller cross sectional area through overlapped segments.

In some embodiments, the shrinkable platform can be formed by multiple segments disposed adjacent to each other to form a simple closed curve, such as each segment is disposed between two adjacent segments. The segments can have external surfaces, e.g., each segment having an external surface. When the segments are disposed next to each other, the external surfaces are also next to each other to form a printing surface for a 3D printer. The printing surface can have no non-printable gaps or steps, e.g., substantially continuous and smooth.

In some embodiments, each segment can have a recess at one end and a portion at an opposite end, which is smaller than the recess and which can fit at least partially inside the recess. The portion can be disposed next to and outside the recess to form the printing surface. To form the shrunk surface, the portion can move toward the recess to be disposed inside the recess. By moving to be inside the recess, the printing surface can be staggered or overlapped, e.g., external surface of a segment can overlap the external surface of an adjacent external surface, since the portion of the external surface a the portion is disposed under the portion of the external surface at the recess. Alternatively, the portion can be disposed partially in the recess to form the printing surface. To form the shrunk surface, the portion can move to be disposed deeper within the recess.

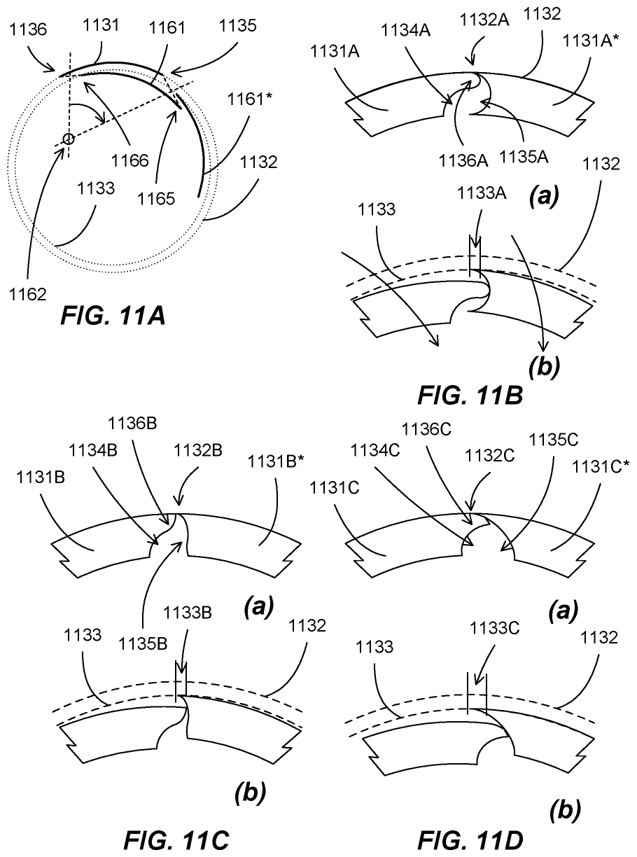

FIGS. 11A-11D illustrate configuration for a segmented platform according to some embodiments. FIG. 11A shows a schematic movement of an external surface 1131 of a segment of the platform in the printing configuration to the external surface 1161 of the same segment in the shrunk configuration. In the printing configuration, an object can be printed on the external surfaces, e.g., the bottom surface of the printed object is the printing surface 1132 of the platform. In the shrunk configuration, the segments are separated from the printed object surface, e.g., from the printing surface 1132 on which the object is printed.

The ends 1136 and 1166 of the external surfaces 1131 and 1161 can be determined, for example, by identifying that the end 1136 is on the printing curve 1132 and the end 1166 is on the shrunk curve 1133. The other ends 1135 and 1165 of the external surfaces 1131 and 1161 can also be determined, for example, by identifying that the end 1135 is on the printing curve 1132 and the end 1165 is inside and spaced from the shrunk curve 1133. Rotational axis 1162 then can be determined so that in a rotation, the ends 1136 and 1135 match the ends 1166 and 1165, respectively. This rotation can rotate the segment inward in the desired configuration, e.g., to provide an overlap with the adjacent segment represented by the external surface 1161*, and by clearing the adjacent segment during the rotation. The rotational movement around the axis 1162 can cause an inward movement of the segment, with a radial component and a tangential component, to allow for the overlap configuration. In some embodiments, the end 1135 of the segment 1131 (e.g., the segment represented by the external surface 1131) can have a recess. The end 1136 of the same segment 1131 can have a portion configured to fit at least partially inside the recess, which can allow the overlapping configuration of two adjacent segments after being rotated around the axis 1162.

FIGS. 11B-11D show configurations of the segments in printing and shrunk configurations. FIGS. 11B(a), 11C(a), and 11D(a) show printing configuration of two adjacent segments. FIGS. 11B(b), 11C(b), and 11D(b) show shrunk configuration of the same two adjacent segments.

In FIG. 11B(a), two adjacent segments 1131A and 1131A* are disposed next to each other to form portions of a printing surface 1132. The interface 1132A between the segments is configured to be suitable for printing, such as there is no non-printable gap or step at the interface 1132A. Each segment can have a recess end 1135A and an opposite portion end 1136A, which is configured to at least partially fit in the recess 1135. For example, the portion end 1136A can have a cut or a removal of material 1134A to reduce the size of the portion end 1136A so that the portion is fit in the recess in the shrunk configuration. The cut or material removal can also shape the portion end to form a continuous and smooth interface with the outside of the recess in the printing configuration.

In FIG. 11B(b), the segments 1131A and 1131A* move inward, e.g., moving toward the rotational axis of the platform, for example, by a rotation around a rotational axis determined, for example, by a process discussed above. The movement can include a radial component and a tangential component, such as in a spiral curve toward the rotational axis. The recess end of the segments is radially moved a smaller distance as compared to the radial movement of the portion end. For example, the recess end can move radially from the printing surface 1132 to a shrunk surface 1133. The portion end can move further inward.

The portion end can be disposed at least partially in the recess end, so that there is an overlap 1133A of the segments or of the external surfaces of the segments. The overlap of the segments can allow the platform to be shrunk, e.g., by moving the segments overlappingly inward.

In FIG. 11C(a), two adjacent segments 1131B and 1131B* are disposed next to each other with no non-printable gap or step at the interface 1132B. The recess end 1135B can be a cut out, such as having a protrusion near the printing surface area and a cut at the portion near the rotational axis. The portion end 1136B can contact the edge of the recess end 1135B. The portion end can be formed by a cut 1134B at the inner side of the segment.

In FIG. 11C(b), the segments move inward to put the portion at least partially in the recess with an overlap 1133B, for example, by a rotation around a rotational axis.

In FIG. 11D(a), two adjacent segments 1131C and 1131C* are disposed next to each other with no non-printable gap or step at the interface 1132C. The recess end 1135C can be a cut out, such as having a protrusion near the printing surface area and a cut at the portion near the rotational axis. The portion end 1136C can have an outer surface partially matching the inner surface of the recess.. The portion end can include a nose portion, extending from the segment.

In FIG. 11D(b), the segments move inward to put the portion at least partially in the recess with an overlap 1133C, for example, by a rotation around a rotational axis.

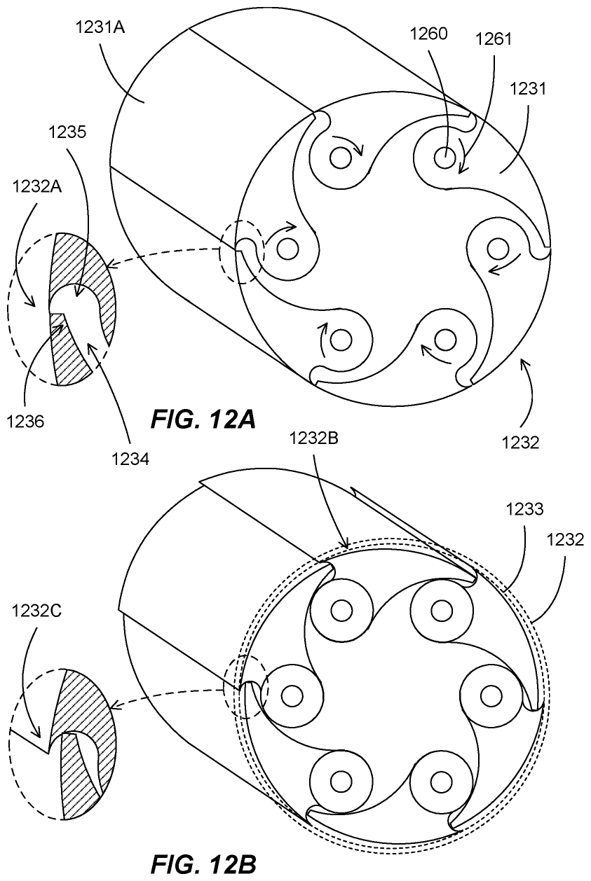

FIGS. 12A-12B illustrate a shrinkable platform according to some embodiments. FIG. 12A shows a printing configuration of a platform. A platform can be formed by multiple segments 1231 arranged next to each other in a closed loop configuration to present a printing surface 1232. The adjacent segments can be disposed close to each other with no non-printable gaps or steps at the interface 1232A between two adjacent segments. Each segment can have an external surface 1231A, which together, form the printing surface 1232 when the platform is in the printing configuration. Each segment can have a recess end 1235 and a portion end 1236 that can fit at least partially inside the recess end. The portion end can be formed by shaping the segments with a cut 1234. The segment can be configured to rotate 1361 around an axis of rotation 1260 that is parallel to an axis of rotation of the platform.

FIG. 12B shows a shrunk configuration of the platform. The segments can be rotated 1261 around the axis of rotation 1260. The axis of rotation is determined so that the recess end 1235 moves inward, for example, to touch 1232B the curve 1233, which is a shrunk printing surface. The shrunk factor can be less than 10%, less than 8%, or less than 5%. In general, the shrunk factor, which is the difference between a dimension of the printing surface 1232 and the same dimension of the shrunk curve over the dimension of the printing surface.

The axis of rotation is determined so that the portion end 1236 enters 1232C the recess of the adjacent segment. Thus, after the rotation of at least one segment, or the rotation of all segments, the platform is in the shrunk configuration, with the platform surface, e.g., the external surfaces of the segments, separated from the bottom surface of the printed object, e.g., the printing surface 1232.

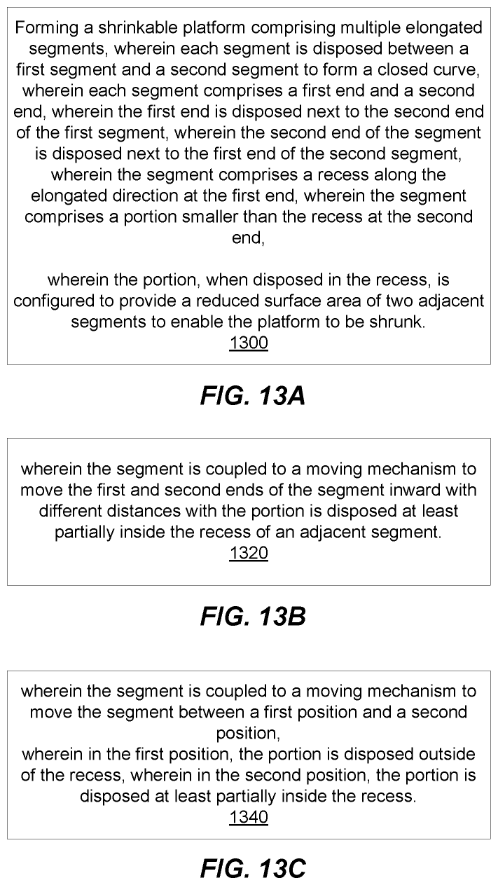

FIGS. 13A-13C illustrate processes for forming shrunk platforms according to some embodiments. In FIG. 13A, operation 1300 forms a shrinkable platform having multiple elongated segments, with each segment disposed between two adjacent segments, such as a first segment and a second segment, to form a simple closed curve, such as a circle. Each segment ca include a recess end and a portion end, wherein the recess end is disposed next to the portion end of the first segment, wherein the portion end of the segment is disposed next to the recess end of the second segment. The segment can include a recess along the elongated direction at the recess end. The segment can include a portion smaller than the recess at the portion end.

The portion, when disposed in the recess, is configured to provide a reduced surface area of two adjacent segments to enable the platform to be shrunk.

In FIG. 13B, operation 1320 provides a limitation that the segment is coupled to a moving mechanism to move the recess and portion ends of the segment inward with different distances with the portion is disposed at least partially inside the recess of an adjacent segment.

In FIG. 13C, operation 1340 provides a limitation that the segment is coupled to a moving mechanism to move the segment between a first position and a second position. In the first position, the portion is disposed outside of the recess. In the second position, the portion is disposed at least partially inside the recess.

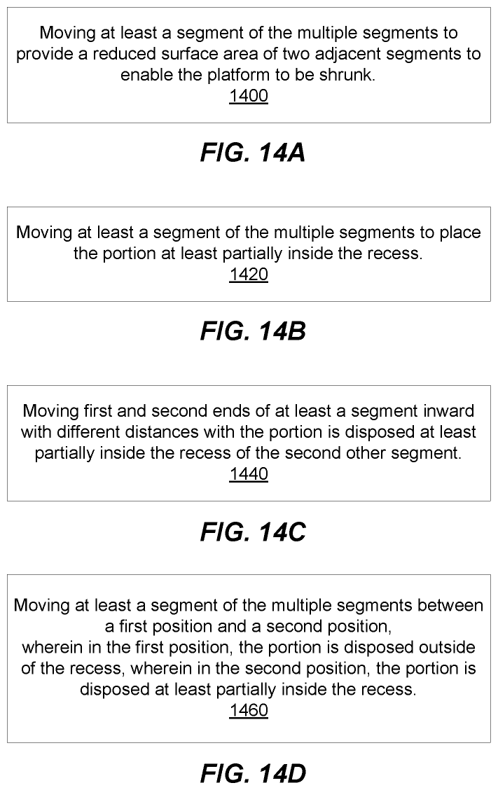

FIGS. 14A-14D illustrate processes for forming shrunk platforms according to some embodiments. In FIG. 14A, operation 1400 moves at least a segment of the multiple segments to provide a reduced surface area of two adjacent segments to enable the platform to be shrunk.

In FIG. 14B, operation 1420 moves at least a segment of the multiple segments to place the portion at least partially inside the recess.

In FIG. 14C, operation 1440 moves first and second ends of at least a segment inward with different distances with the portion is disposed at least partially inside the recess of the second other segment.

In FIG. 14D, operation 1460 moves at least a segment of the multiple segments between a first position and a second position. In the first position, the portion is disposed outside of the recess. In the second position, the portion is disposed at least partially inside the recess.

In some embodiments, the segments of the platform can be configured to provide movements that can shrink the platform surface, such as moving the segments from an adjacent configuration to an overlap configuration. For example, the segments can be configured to provide rotational movements, such as by a movement mechanism, e.g., using a motor or a hydraulic or pneumatic cylinder, coupling to the segments through a set of gears. Alternatively, the movement mechanism can include an external component, which can be inserted to the platform for moving the segments.

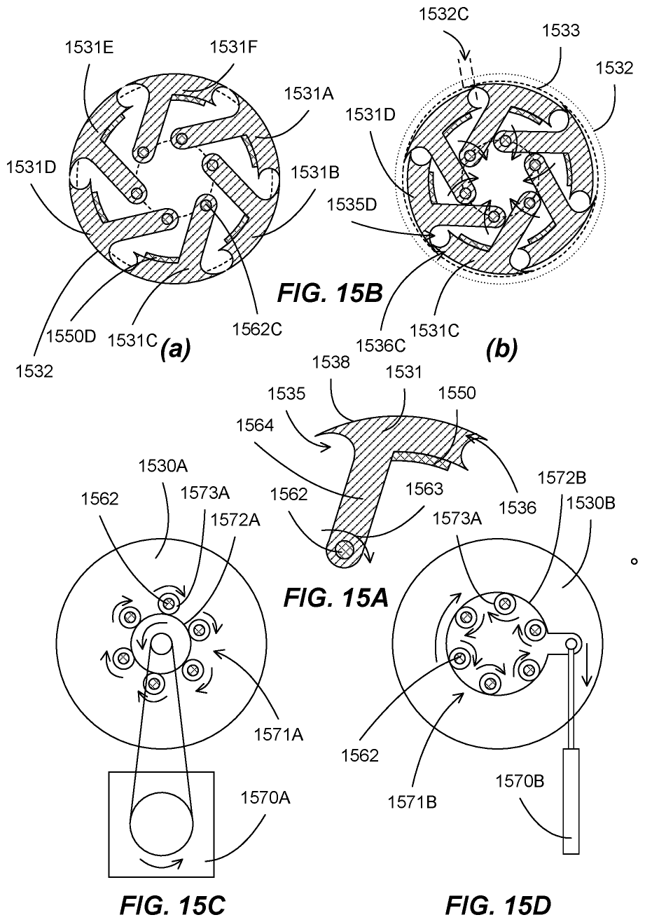

FIGS. 15A-15D illustrate movement configurations of a segmented platform according to some embodiments. FIG. 15A shows a segment 1531 of a segmented platform. The segment 1531 includes an external surface 1538, which is a portion of the printing surface. The segment 1531 is one of the multiple segments of the segmented platform. The segments can be disposed so that the external surfaces of the segments form the printing surface.

The segment 1531 can have a recess end 1535 which includes a recess. The segment 1531 can have a portion end 1536 which includes a portion that can fit at least partially in the recess. The segment 1531 can have an arm 1564, which can extend to the rotational axis 1562. By rotating 1563 around the rotational axis 1562, the segment 1531 can move to the shrunk configuration, with overlapped external surface caused by the portion end disposed at least partially in the recess end, which can separate the printed object from the platform for ease of removal. A heater 1550 can be coupled to the segment 1531 to heat the segment.

FIGS. 15B(a) and 15B(b) show a printing configuration and a shrunk configuration of a segmented platform having multiple segments having recess and portion ends and extended arm for coupling to rotational axis. Multiple segments 1531A-1531F can be arranged in a circular configuration, with the external surfaces of the segments form a printing surface 1532. The rotational axes of the segments are also arranged in a circle.

The segments can rotate to form the shrunk configuration, with the external surfaces of the segments now are disposed on or inside a shrunk curve 1533, which can be a curve uniformly shrunk from the printing surface. In the shrunk configuration, the portion end 1536C of segment 1531C is disposed inside the recess end 1535D of adjacent segment 1531D, to provide an overlap such as overlap 1532C.

FIG. 15C shows a configuration for a rotating mechanism to move the segments of a segmented platform 1530A between a printing configuration and a shrunk configuration. The rotating mechanism can include a motor 1570A, which is coupled to a gear set 1571A, which is coupled to the rotational axes 1562 at the arms of the segments. The motor can rotate, and the rotational motion of the motor can transfer to a rotational motion of a gear 1572A coupled to the multiple gears 1573A on the segment arms. The rotational motion of the gears 1573A can rotate the segments to move the segments between the printing position, in which the segments are disposed next to each other, and the shrunk configuration, in which the segments are overlapped with the portion of one segment disposed partially in the recess of an adjacent segment.

FIG. 15D shows a configuration for a linear movement mechanism to move the segments of a segmented platform 1530B between a printing configuration and a shrunk configuration. The linear movement mechanism can include a hydraulic or pneumatic cylinder 1570B, which is coupled to a gear set 1571B, which is coupled to the rotational axes 1562 at the arms of the segments. The cylinder can extend and retract, and the linear motion of the cylinder can transfer to a rotational motion of a gear 1572B coupled to the multiple gears 1573B on the segment arms. The rotational motion of the gears 1573B can rotate the segments to move the segments between the printing position, in which the segments are disposed next to each other, and the shrunk configuration, in which the segments are overlapped with the portion of one segment disposed partially in the recess of an adjacent segment.

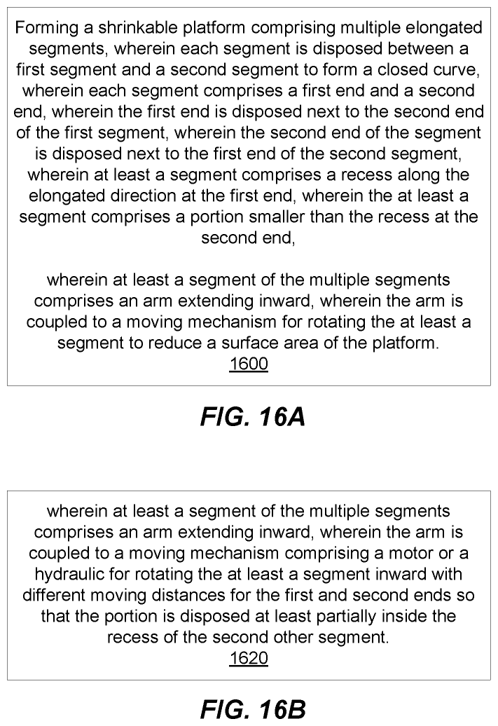

FIGS. 16A-16B illustrate configurations of a segmented platform in which the segments are rotatable according to some embodiments. In FIG. 16A, operation 1600 forms a shrinkable platform having multiple elongated segments, with each segment disposed between a first segment and a second segment to form a closed curve. The each segment can include a first end and a second end, with the first end disposed next to the second end of the first segment, and the second end of the segment disposed next to the first end of the second segment. At least a segment has a recess along the elongated direction at the first end, and a portion smaller than the recess at the second end.

The at least a segment of the multiple segments can have an arm extending inward, which is coupled to a moving mechanism for rotating the at least a segment to reduce a surface area of the platform.

In FIG. 16B, operation 1620 provides a limitation that the at least a segment of the multiple segments has an arm extending inward, which is coupled to a moving mechanism comprising a motor or a hydraulic for rotating the at least a segment inward with different moving distances for the first and second ends so that the portion is disposed at least partially inside the recess of the second other segment.

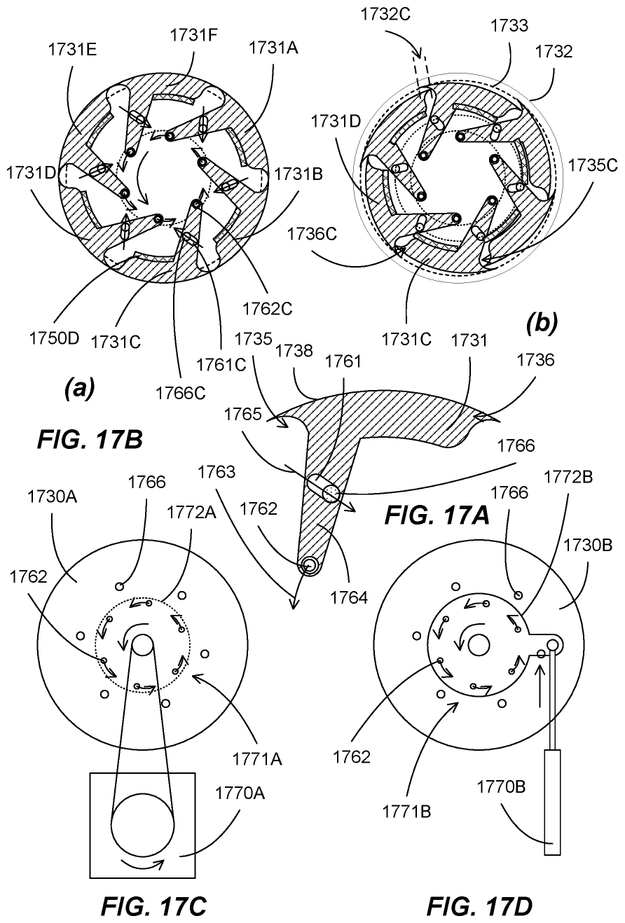

FIGS. 17A-17D illustrate movement configurations of a segmented platform according to some embodiments. FIG. 17A shows a segment 1731 of a segmented platform. The segment 1731 includes an external surface 1738, which is a portion of the printing surface. The segment 1731 is one of the multiple segments of the segmented platform. The segments can be disposed so that the external surfaces of the segments form the printing surface.

The segment 1731 can have a recess end 1735 which includes a recess. The segment 1731 can have a portion end 1736 which includes a portion that can fit at least partially in the recess. The segment 1731 can have an arm 1764, which can extend to the movement pin 1762. The segment 1731 can have a guide 1761, which can be in the form of a slot, which together with a stationary pin 1766, can guide 1765 the movement of the segment 1731 when the segment is moved by pulling on the movement pin 1762.

By moving 1763 the movement pin 1762, for example, around the rotational axis of the platform, the segment 1731 can move to the shrunk configuration, with overlapped external surface caused by the portion end disposed at least partially in the recess end, which can separate the printed object from the platform for ease of removal. For example, the movement pin 1762 can move downward, which can move the segment along the slot 1761 respect to the stationary pin 1766

FIGS. 17B(a) and 17B(b) show a printing configuration and a shrunk configuration of a segmented platform having multiple segments having recess and portion ends and extended arm for coupling to rotational axis. Multiple segments 1731A-1731F can be arranged in a circular configuration, with the external surfaces of the segments form a printing surface 1732. The rotational axes of the segments are also arranged in a circle.

The segments can move to form the shrunk configuration, with the external surfaces of the segments now are disposed on or inside a shrunk curve 1733, which can be a curve uniformly shrunk from the printing surface. For example, the movement pin 1762C of segment 1731C can rotate around the rotational axis of the platform, which moves the segment 1731C along the slot 1765C, guided by the stationary pin 1766C. In the shrunk configuration, the portion end 1736C of segment 1731C is disposed inside the recess end 1735D of adjacent segment 1731D, to provide an overlap such as overlap 1732C.

FIG. 17C shows a configuration for a rotating mechanism to move the segments of a segmented platform 1730A between a printing configuration and a shrunk configuration. The rotating mechanism can include a motor 1770A, which is coupled to a gear set 1771A, which is coupled to the movement pins 1762 at the arms of the segments. The motor can rotate, and the rotational motion of the motor can transfer to a rotational motion of a gear 1772A coupled to the multiple movement pins 1762 on the segment arms. The motion of the movement pins 1762 can move the segments along guide 1761 by the stationary pins 1766 to move the segments between the printing position, in which the segments are disposed next to each other, and the shrunk configuration, in which the segments are overlapped with the portion of one segment disposed partially in the recess of an adjacent segment.

FIG. 17D shows a configuration for a linear movement mechanism to move the segments of a segmented platform 1730B between a printing configuration and a shrunk configuration. The linear movement mechanism can include a hydraulic or pneumatic cylinder 1770B, which is coupled to a gear set 1771B, which is coupled to the movement pins 1762 at the arms of the segments. The cylinder can extend and retract, and the linear motion of the cylinder can transfer to a rotational motion of a gear 1772B coupled to the movement pins 1762 on the segment arms. The motion of the movement pins 1762 can move the segments along guide 1761 by the stationary pins 1766 to move the segments between the printing position, in which the segments are disposed next to each other, and the shrunk configuration, in which the segments are overlapped with the portion of one segment disposed partially in the recess of an adjacent segment.

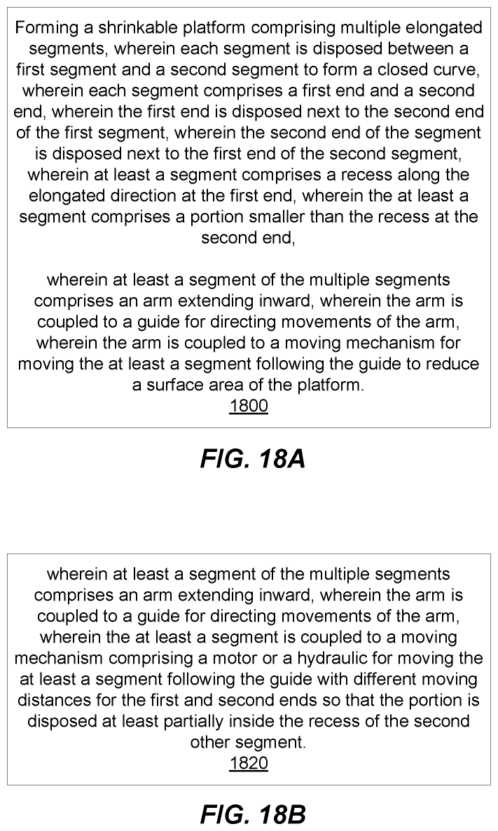

FIGS. 18A-18B illustrate configurations of a segmented platform in which the segments are rotatable according to some embodiments. In FIG. 18A, operation 1800 forms a shrinkable platform having multiple elongated segments, with each segment disposed between a first segment and a second segment to form a closed curve, and with each segment having a first end and a second end, with the first end disposed next to the second end of the first segment, and the second end of the segment is disposed next to the first end of the second segment. At least a segment has a recess along the elongated direction at the first end, and a portion smaller than the recess at the second end,

The at least a segment of the multiple segments can have an arm extending inward, with the arm coupled to a guide for directing movements of the arm, and also coupled to a moving mechanism for moving the at least a segment following the guide to reduce a surface area of the platform.

In FIG. 18B, operation 1820 provides a limitation that the at least a segment of the multiple segments can have an arm extending inward, with the arm coupled to a guide for directing movements of the arm. The at least a segment can be coupled to a moving mechanism having a motor or a hydraulic for moving the at least a segment following the guide with different moving distances for the first and second ends so that the portion is disposed at least partially inside the recess of the second other segment.

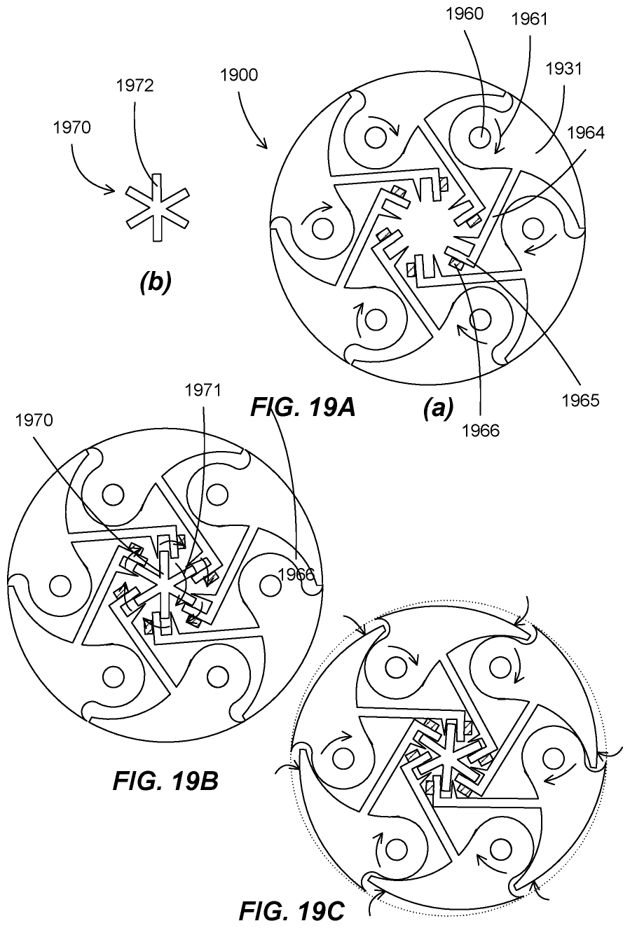

FIGS. 19A-19C illustrate a configuration of a segmented platform according to some embodiments. FIG. 19A(a) shows segments 1931 of a segmented platform 1900 in a printing configuration, e.g., the segments are disposed so that the external surfaces of the segments form the printing surface.

Each segment 1931 can have a recess end which includes a recess. The segment 1931 can have a portion end which includes a portion that can fit at least partially in the recess. The segment 1931 can have an axis of rotation 1960, e.g., the segment 1931 can rotate around the axis 1960, to move the segment from a printing configuration to a shrunk configuration. By rotating 1961 around the rotational axis 1960, the segment 1931 can move from the printing configuration to the shrunk configuration, with overlapped external surface caused by the portion end disposed at least partially in the recess end, which can separate the printed object from the platform for ease of removal. A heater can be coupled to the segment 1931 to heat the segment.

The segment 1931 can have an arm 1964, which can include a hook element 1965. The hook element 1965 can have two hooks, which can allow the segment 1931 to rotate in two different directions. Alternatively, the hook element can have one hook, which is configured to rotate the segment 1931 in one direction. The rotation in the opposite direction can be performed by a spring or an actuator 1966. For example, a spring or an actuator 1966 can be included to bias the segment 1931 into the printing configuration, e.g., under normal operating conditions, the spring 1966 can push the segment 1931 to form a close curve surface, e.g., a surface suitable for printing.

FIG. 19A(b) shows an external component 1970, which can be used to rotate the segment 1931. The external component 1970 can have one or more fins 1972, which is configured to mate with the hooks 1965 of the arm 1964 of the segment 1931.

FIGS. 19B and 19C show an operation of the segmented platform from a printing configuration in FIG. 19B to a shrunk configuration in FIG. 19C. The external component 1970 can be inserted into the segmented platform 1900, so that the fins 1972 of the external component 1970 are mated with the hooks 1964 of the segment 1931.

As shown, the external component 1970 has multiple fins 1972, which correspond to the hooks of the multiple segments 1931 of the segmented platform. In this configuration, a rotation 1971 of the external component 1970 can rotate all segments of the segmented platform. Alternative, the external component can have few fins, such as only one fin, which can be mated with one hook of a segment 1931, and which can rotate only the segment 1931 that is hooked to the fin.

The external component 1970 can rotate 1971, which can force the segments to rotate to form the shrunk configuration. The external surface of the segment 1931 can move radially inward, e.g., forming a space with the printing surface, which can allow the printed object to be separated from the printed surface.

The external component 1970 can rotate in an opposite direction to return the segmented platform from the shrunk configuration back to the printing configuration. Alternatively, by releasing the external component, e.g., not rotating 1971 the external component, the spring 1966 can return the segments to the printing configuration.

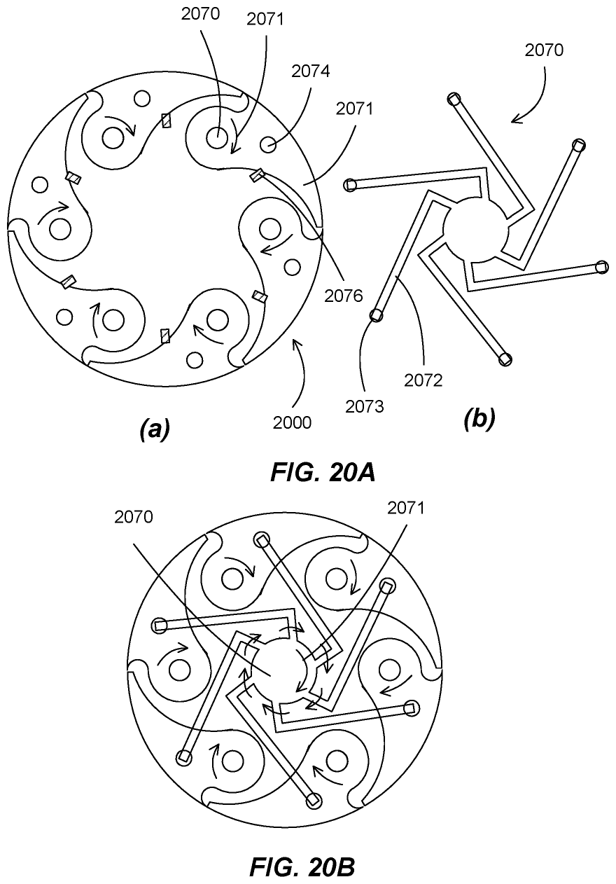

FIGS. 20A-20C illustrate a configuration of a segmented platform according to some embodiments. FIG. 20A(a) shows segments 2031 of a segmented platform 2000 in a printing configuration, e.g., the segments are disposed so that the external surfaces of the segments form the printing surface.

Each segment 2031 can have a recess end which includes a recess. The segment 2031 can have a portion end which includes a portion that can fit at least partially in the recess. The segment 2031 can have an axis of rotation 2060, e.g., the segment 2031 can rotate around the axis 2060, to move the segment from a printing configuration to a shrunk configuration. By rotating 2061 around the rotational axis 2060, the segment 2031 can move from the printing configuration to the shrunk configuration, with overlapped external surface caused by the portion end disposed at least partially in the recess end, which can separate the printed object from the platform for ease of removal. A heater can be coupled to the segment 2031 to heat the segment.

The segment 2031 can have an opening 2064. A spring or an actuator 2066 can be included to bias the segment 2031 into the printing configuration, e.g., under normal operating conditions, the spring 2066 can push the segment 2031 to form a close curve surface, e.g., a surface suitable for printing.

FIG. 20A(b) shows an external component 2070, which can be used to rotate the segment 2071. The external component 2070 can have one or more fins 2072, which can have a mating element 2073 to mate with the opening 2064 of the segment 2031.

FIGS. 20B and 20A(a) show an operation of the segmented platform from a printing configuration in FIG. 20B to a shrunk configuration in FIG. 20A(a). The external component 2070 can be inserted into the segmented platform 2000, so that the mating elements 2073 of the external component 2070 are mated with the opening 2064 of the segment 2071.

As shown, the external component 2070 has multiple fins 2072, which correspond to the openings of the multiple segments 2031 of the segmented platform. In this configuration, a rotation 2071 of the external component 2070 can rotate all segments of the segmented platform. Alternative, the external component can have few fins, such as only one fin, which can be mated with one opening of a segment 2031, and which can rotate only the segment 2031 that is mated to the fin.

The external component 2070 can rotate 2071, which can force the segments to rotate to form the shrunk configuration. The external surface of the segment 2031 can move radially inward, e.g., forming a space with the printing surface, which can allow the printed object to be separated from the printed surface.

The external component 2070 can rotate in an opposite direction to return the segmented platform from the shrunk configuration back to the printing configuration. Alternatively, by releasing the external component, e.g., not rotating 2071 the external component, the spring 2066 can return the segments to the printing configuration.

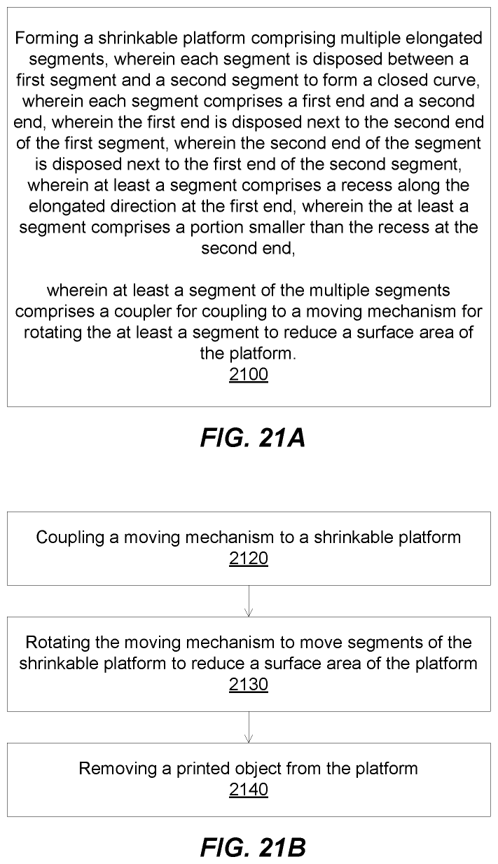

FIGS. 21A-21B illustrate configurations and operations of a segmented platform according to some embodiments. In FIG. 21A, operation 2100 forms a shrinkable platform having multiple elongated segments, with each segment disposed between a first segment and a second segment to form a closed curve, and with each segment having a first end and a second end, with the first end disposed next to the second end of the first segment, and the second end of the segment is disposed next to the first end of the second segment. At least a segment has a recess along the elongated direction at the first end, and a portion smaller than the recess at the second end,

The at least a segment of the multiple segments can include a coupler for coupling to a moving mechanism for rotating the at least a segment to reduce a surface area of the platform.

In FIG. 21B, operation 2120 couples a moving mechanism to a shrinkable platform. Operation 2130 rotates the moving mechanism to move segments of the shrinkable platform to reduce a surface area of the platform. Operation 2140 removes a printed object from the platform,

In some embodiments, the present invention discloses an attachment for a 3D printer having a flat platform. The attachment can include a shrinkable and rotatable platform, and a coupler configured to be coupled to the flat platform.

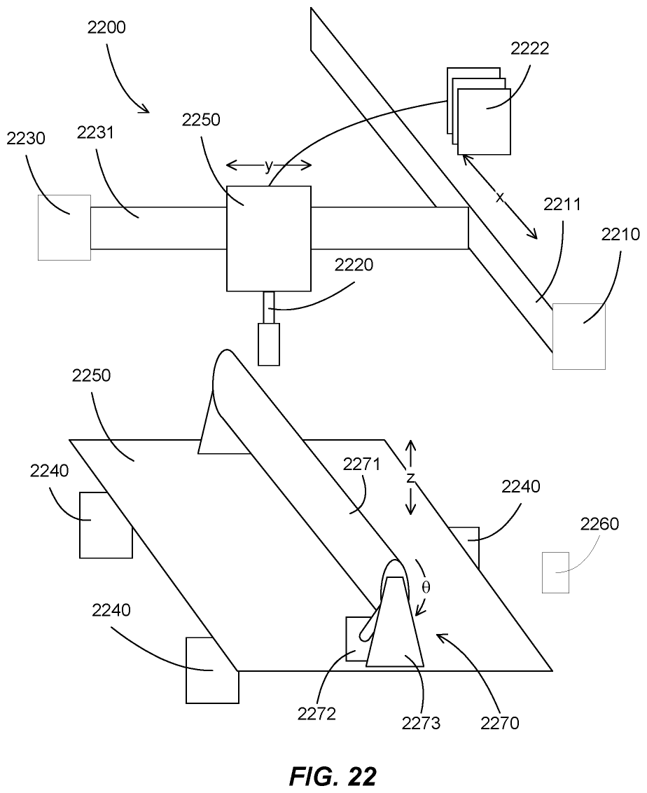

FIG. 22 illustrates an attachment coupled to a 3D printer according to some embodiments. A 3D printer 2200 an have a print head 2220 configured to print on a flat platform 2250. The print head can be coupled to a material delivery system 2222, which can deliver materials to the print head. The print head 2220 can be coupled to a y movement mechanism, such which can include a linear guide 2231, which is driven by a motor 2230. The print head and the y movement mechanism can be coupled to an x movement mechanism, which can include a linear guide 2211, which is driven by a motor 2210.

A z movement mechanism can be coupled to the print head 2220 or to the flat platform for moving the print head relative to the flat platform in the z direction. For example, a z movement mechanism 2240 can be coupled to the platform 2250 to move the platform in the z direction. A controller 2260 can be used to control the 3D printer system.

An attachment 2270 can have a shrinkable and rotatable platform 2271 can be coupled to the flat platform 2250 of the 3D printer 2200, for example, through a coupler 2273. The rotatable platform 2271 can be coupled to a movement mechanism 2272, which can include a motor driving the rotatable platform through a timing belt or through a lead or ball screw. The shrinkable platform 2271 can include a multiple segments coupled to another movement mechanism to move the segments between a printing configuration and a shrunk configuration.

A coupler 2273 can be coupled to the platform 2271, for example, through ball bearings at the axis of rotation of the platform. The coupler can be coupled to the flat platform, for example, through a set of bolts or screws for securing the coupler to the flat platform.

What is claimed is:

1. A platform comprising
multiple segments,
wherein each segment of the multiple segments is disposed between two other segments of the multiple segments,
wherein the platform is coupled to a rotating mechanism configured to rotate the multiple segments around an axis of rotation,
wherein at least a segment of the multiple segments is coupled to a moving mechanism configured to move the at least a segment between a first position and a second position,
wherein in the first position, first cross sectional areas of the multiple segments formed by a plane through the axis of rotation are disposed inside and contacting a first simple closed curve,
wherein in the second position, second cross sectional areas of the multiple segments formed by the plane are disposed inside without contacting the first simple closed curve.

2. A platform as in claim 1
wherein the second cross sectional areas are disposed inside a uniformly shrunk first simple closed curve.

3. A platform as in claim 1
wherein each segment of the multiple segment comprises an external surface,
wherein the first simple closed curve comprises sections of the external surfaces of the multiple segments intersecting the plane,

4. A platform as in claim 1
wherein in the second position, second cross sectional areas of the multiple segments formed by the plane are disposed inside and contacting a second simple closed curve,
wherein the area of the second simple closed curve is smaller in that of the first simple closed curve, or the second simple curve is a uniformly, offsetly, or wrinklely shrunk first simple closed curve.

5. A platform as in claim 1
wherein each segment of the multiple segment comprises an external surface,
wherein in the first position, the external surfaces are adjacent of each other,
wherein in the second position, the external surfaces are spaced apart in a radial direction.

6. A platform as in claim 1
wherein each segment of the multiple segment comprises an external surface,
wherein in the first position, the external surfaces are adjacent of each other to form a substantially smooth surface,
wherein in the second position, the external surfaces overlap along the circumferential direction of the first simple closed curve.

7. A platform as in claim 1
wherein the segments are configured to move inwardly with different radial distances to provide a smaller diameter curve or a smaller cross sectional area.

8. A platform as in claim 1
wherein the segments are movable or rotatable to form overlapped segments to provide a smaller diameter curve or a smaller cross sectional area.

9. A platform as in claim 1
wherein the at least a segment comprises a recess at a first end,
wherein the at least a segment comprises a portion smaller than the recess at a second end.

10. A platform as in claim 1
wherein the at least a segment comprises a recess at a first end,
wherein the at least a segment comprises a portion smaller than the recess at a second end,
wherein the at least a segment of the multiple segments is configured to be movable to place the portion of the at least a segment at least partially inside a recess of an adjacent segment.

11. A platform as in claim 1
wherein the at least a segment comprises a recess at a first end,
wherein the at least a segment comprises a portion smaller than the recess at a second end,
wherein the at least a segment is coupled to a moving mechanism that is configured to move the second end of the at least a segment radially inward so that the portion of the at least a segment is disposed at least partially inside a recess of an adjacent segment.

12. A platform as in claim 1
wherein the at least a segment comprises a recess at a first end,
wherein the at least a segment comprises a portion smaller than the recess at a second end,
wherein in the first position, the portion of the at least a segment is disposed outside of a recess of an adjacent segment,
wherein in the second position, the portion of the at least a segment is disposed at least partially inside the recess of the adjacent segment.

13. A platform as in claim 1
wherein the at least a segment comprises an arm extending inward, wherein the arm is coupled to a moving mechanism for rotating the at least a segment radially inward.

14. A platform as in claim 1
wherein the at least a segment comprises an arm extending inward, wherein the arm is coupled to a guide for directing movements of the arm, wherein the arm is coupled to a moving mechanism for moving the at least a segment radially inward following the guide.

15. A platform as in claim 1
wherein the at least a segment comprises a coupler, wherein the coupler is configured to be coupled to a moving mechanism for moving the at least a segment radially inward.

16. A platform as in claim 1 further comprising
a heater coupled to the platform for heating the multiple segments.

17. A 3D printer comprising
a print head,
wherein the print head comprises a heated chamber and a rotating mechanism configured to deliver a molten material from the heated chamber to a nozzle;
a first movement mechanism directly or indirectly coupled to the print head and configured to move the print head along a first linear guide along a first direction;
a platform comprising multiple segments,
wherein each segment of the multiple segments is disposed between two other segments of the multiple segments,
wherein the platform is coupled to a rotating mechanism configured to rotate the multiple segments around an axis of rotation,
wherein at least a segment of the multiple segments is coupled to a moving mechanism configured to move the at least a segment between a first position and a second position,
wherein in the first position, first cross sectional areas of the multiple segments formed by a plane through the axis of rotation are disposed inside and contacting a first simple closed curve,
wherein in the second position, second cross sectional areas of the multiple segments formed by the plane are disposed inside without contacting the first simple closed curve;
a rotating mechanism coupled to the platform and configured to rotate the first surface;
a second movement mechanism coupled to the print head or to the platform and configured to move the print head relative to the platform along a second linear guide along a second direction.

18. A 3D printer as in claim 1,
wherein the axis of rotation is parallel to the first direction.

19. An attachment for a 3D printer, the attachment comprising
a rotatable platform comprising multiple segments,
wherein each segment of the multiple segments is disposed between two other segments of the multiple segments,
wherein the platform is coupled to a rotating mechanism configured to rotate the multiple segments around an axis of rotation,
wherein at least a segment of the multiple segments is coupled to a moving mechanism configured to move the at least a segment between a first position and a second position,
wherein in the first position, first cross sectional areas of the multiple segments formed by a plane through the axis of rotation are disposed inside and contacting a first simple closed curve,
wherein in the second position, second cross sectional areas of the multiple segments formed by the plane are disposed inside without contacting the first simple closed curve;
an adapter coupled to the rotatable platform, wherein the adapter is configured to be mounted on a flat platform of a 3D printer.

20. An attachment for a 3D printer as in claim 19, further comprising
an alignment coupled to the flat platform,
wherein the alignment is configured to align the axis of rotation to a linear guide of the 3D printer.
